(19) United States
(12) Patent Application Publication
(10) Pub. No.: US 2010/0036661 A1
(43) Pub. Date: Feb. 11, 2010

(54) Methods and Systems for Providing Grammar Services

(75) Inventors: Dominique Boucher, Montreal (CA); Yves Normandin, St-Hubert (CA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NU ECHO INC., Montreal (CA)

(21) Appl. No.: 12/503,616

(22) Filed: Jul. 15, 2009

Related U.S. Application Data
(60) Provisional application No. 61/080,837, filed on Jul. 15, 2008.

(51) Int. Cl. G10L 15/06; G10L 15/26

(52) U.S. Cl. 704/235; 704/243; 704/E15.007; 704/E15.045

(57) ABSTRACT

A computing system, comprising: an I/O platform for interfacing with a user; and a processing entity configured to implement a dialog with the user via the I/O platform. The processing entity is further configured for: identifying a grammar template and an instantiation context associated with a current point in the dialog; causing creation of an instantiated grammar model from the grammar template and the instantiation context; storing the instantiated grammar model in a memory; and interpreting user input received via the I/O platform in accordance with the instantiated grammar model. Also, a grammar authoring environment supporting a variety of grammar development tools is disclosed.

### CROSS-REFERENCE(S) TO RELATED APPLICATION(S)

The present application claims the benefit under 35 USC §119(e) of United States Provisional Patent Application Ser. No. 61/080,837 to Dominique Boucher and Yves Normandin, filed Jul. 15, 2008, hereby incorporated by reference herein.

### BACKGROUND

The addition of speech recognition capabilities to a telephony application necessarily requires the use of speech grammars. A speech grammar is a text file written in a specific syntactical format that specifies all possible sentences which can be recognized by an automatic speech recognition (ASR) engine at a given point in a spoken dialog. In addition to specifying all possible sentences that can be recognized by the ASR engine, the grammar can include specific instructions (referred to as “semantic action tags”) used to aid in computing the semantic interpretation (i.e., value or meaning) corresponding to any of the allowed sentences. A standard for grammars has been developed by the World Wide Web Consortium (W3C). This standard specifies two different (but equivalent) syntactical formats for a grammar, namely the “XML” (extended markup language) syntactical format and the “ABNF” (advanced Backus-Naur form) syntactical format.

The grammar is then compiled by a compiler into a binary string which is then loaded by the ASR engine prior to processing a spoken utterance. The grammar compilation process, which can be performed offline or by the ASR engine on-the-fly, usually adds phonetic pronunciations for words found in the grammar (based on a system pronunciation lexicon and/or user-provided pronunciation lexicons) and, based on these phonetic pronunciations, also adds information regarding the acoustic models that will be used by the grammar during recognition.

A typical application employing a speech grammar operates as follows. Firstly, a prompt is issued, to which a speaker responds by uttering a response. An ASR engine is provided with a grammar, which is used to recognize the speaker's utterances, i.e., to transform the received speech into literal text (raw recognized text). In a simple “static” scenario, the grammar is known ahead of time. In a more complex “dynamic” scenario, the grammar is a function of various information available at run-time. The grammar is then also used by the ASR for semantic interpretation, namely to determine the meaning (or value) of what was recognized as having been spoken. The semantic interpretation is then returned, together with the raw recognized text, in the form of speech recognition results. In particular, speech recognition results often contain a list of recognition hypotheses in decreasing confidence order, each of which contains raw recognized text, a semantic interpretation and other information, for instance word and sentence confidence scores.

It is apparent that the skill set required to create a dialog for a speech application is different from the skill set required to develop a grammar. In particular, implementing a dialog usually requires software development (programming) skills, while grammar development is often done by linguists or “voice user interface (VUI) developers”, who are often not programmers. When a complex dynamic grammar is to be used in a speech application, this requires the grammar developer to possess the additional skills of a software programmer, which is not usually the case. Therefore, it would be beneficial to provide a tool to assist grammar developers in creating both static and dynamic grammars that have the requisite software structure so as to facilitate their use in a speech application.

Also, the architecture of a conventional ASR engine may not be satisfactory and further improvements in this area are also welcome.

### SUMMARY OF THE INVENTION

According to a first broad aspect, the present invention seeks to provide a computing system, comprising: an I/O platform for interfacing with a user; and a processing entity configured to implement a dialog with the user via the I/O platform. The processing entity is further configured for: identifying a grammar template and an instantiation context associated with a current point in the dialog; causing creation of an instantiated grammar model from the grammar template and the instantiation context; storing the instantiated grammar model in a memory; and interpreting user input received via the I/O platform in accordance with the instantiated grammar model.

According to a second broad aspect, the present invention seeks to provide a method, comprising: identifying a grammar template and an instantiation context associated with a current point in a dialog with a user that takes place via an I/O platform; causing creation of an instantiated grammar model from the grammar template and the instantiation context data; storing the instantiated grammar model in a memory; and interpreting user input received via the I/O platform in accordance with the instantiated grammar model.

According to a third broad aspect, the present invention seeks to provide a computer-readable storage medium storing instructions for execution by a computer, wherein the instructions, when executed by a computer, cause the computer to implement a method, comprising: identifying a grammar template and an instantiation context associated with a current point in a dialog with a user that takes place via an I/O platform; causing creation of an instantiated grammar model from the grammar template and the instantiation context data; storing the instantiated grammar model in a memory; and interpreting user input received via the I/O platform in accordance with the instantiated grammar model.

According to a fourth broad aspect, the present invention seeks to provide an apparatus for sentence generation comprising: a memory; an output; and a processing entity configured for: identifying a grammar template and an instantiation context; causing creation an instantiated grammar model from the grammar template and the instantiation context; storing the instantiated grammar model in the memory; generating at least one sentence constrained by the instantiated grammar model; and releasing the at least one sentence via the output.

According to a fifth broad aspect, the present invention seeks to provide a method, comprising: identifying a grammar template and an instantiation context; causing creation of an instantiated grammar model from the grammar template and the instantiation context data; storing the instantiated grammar model in a memory; generating a sentence constrained by the instantiated grammar model; and releasing the sentence via an output.

According to a sixth broad aspect, the present invention seeks to provide a computer-readable storage medium storing instructions for execution by a computer, wherein the instructions, when executed by a computer, cause the computer to implement a method, comprising: identifying a grammar template and an instantiation context; causing creation an instantiated grammar model from the grammar template and the instantiation context data; storing the instantiated grammar model in a memory; generating a sentence constrained by the instantiated grammar model; and releasing the sentence via an output.

According to a seventh broad aspect, the present invention seeks to provide a computing device comprising a memory, a user interface and a processing unit, the memory storing instructions for execution by the processing unit, the memory further storing a grammar template, the memory further storing rules associated with a grammar template language, wherein the instructions, when executed by the processing unit, cause the processing entity to interpret the grammar template in accordance with the rules associated with the grammar language such that wherein when the grammar template includes dynamic fragments written in accordance with the grammar template language, the processing entity is responsive to identify the dynamic fragments and to control the user interface so as to render the dynamic fragments distinguishable from non-dynamic fragments.

According to an eighth broad aspect, the present invention seeks to provide a computer-readable storage medium storing instructions for execution by a computer, wherein the instructions, when executed by a computer, cause the computer to implement a plurality of grammar development tools and a graphical user interface, wherein the graphical user interface allows a user of the computer to invoke at least one of the grammar development tools, wherein at least one of the grammar development tools (i) allows a user to edit a grammar template via the graphical user interface; (ii) recognizes dynamic fragments in the grammar template; and (iii) identifies the dynamic fragments to the user via the graphical user interface.

According to a ninth broad aspect, the present invention seeks to provide a computer-readable storage medium storing instructions for execution by a computer, wherein the instructions, when executed by a computer, cause the computer to implement a plurality of grammar development tools and a graphical user interface, wherein the graphical user interface allows a user of the computer to invoke at least one of the grammar development tools, wherein at least one the grammar development tools allows a user to (i) edit a grammar template via the graphical user interface and (ii) specify an instantiation context for use with the grammar template, wherein the instructions, when executed by the computer, further cause the computer to (i) instantiate the grammar template with the instantiation context to produce an instantiated grammar model and (ii) convey the instantiated grammar model to the user via the graphical user interface in a selected grammar format.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram illustrating the process of grammar instantiation using a grammar template and an instantiation context, in accordance with a specific non-limiting embodiment of the present invention FIG. 2 is a block diagram illustrating various components of a speech platform that utilizes grammar instantiation as depicted in FIG. 1, in accordance with a specific non-limiting embodiment of the present invention;

FIG. 3 is a signal flow diagram illustrating possible signal flow in a scenario involving speech recognition and semantic interpretation based on speech input provided by a user;

FIG. 4 is a block diagram depicting a grammar server that encompasses various functional entities depicted in FIG. 2, including a functional entity for grammar generation, a functional entity for grammar instantiation and a functional entity for semantic interpretation;

FIG. 5 is a block diagram depicting a variant in which there is no application server explicitly indicated;

FIG. 6 is a block diagram depicting a variant in which the application server is responsible for grammar generation, grammar instantiation and semantic interpretation;

FIG. 7 is a block diagram illustrating a variant of FIG. 2, in which a messaging platform I provided for exchanging textual messages with the user, in accordance with a specific non-limiting embodiment of the present invention;

FIG. 8 is a signal flow diagram illustrating possible signal flow in a scenario involving semantic interpretation based on textual input provided by the user;

FIG. 9 is a block diagram illustrating a variant of FIG. 2, in which a VoiceXML emulator is used to exchange text with the user, in accordance with a specific non-limiting embodiment of the present invention;

FIG. 10 is a block diagram illustrating a computer that supports a grammar authoring environment, including the making available of grammar development tools to a user;

FIGS. 11-15 are screen shots illustrating various grammar development tools, in accordance with specific non-limiting embodiments of the present invention.

It is to be expressly understood that the description and drawings are only for the purpose of illustration of certain embodiments of the invention and are an aid for understanding. They are not intended to be a definition of the limits of the invention.

### DETAILED DESCRIPTION

In a dynamic scenario, the grammar used by an ASR engine at a given point in the dialog with a speaker is a function of input data whose value is not known until the dialog takes place, i.e., until run-time. Such data can include the response to a previous prompt, the date/time at which the call takes place, the CLID (calling line identification) or DNIS (dialed number identification service) associated with the call, data found in a repository (a list of names or companies), and so on. Yet, while the grammar itself (i.e., the text file having a specific syntactical format such as ABNF or XML) is not known until run-time, its structure—including the identification of variables whose values are unknown a priori—can be encoded using a grammar template written in a specialized “grammar template language”. Specifically, when written in the grammar template language, a grammar template specifies variables whose values will become fixed at run-time by instantiating the grammar template with an “instantiation context” referred to in the grammar template.

Instantiation of the grammar template with the instantiation context thus results in an “instantiated grammar model”, which is an internal, in-memory model of the grammar resulting from the instantiation process. The instantiated grammar model can be in the form of an abstract syntax tree (AST), for example. The instantiated grammar model can then be transformed into a generated grammar in any given format (e.g., XML, ABNF, etc.).

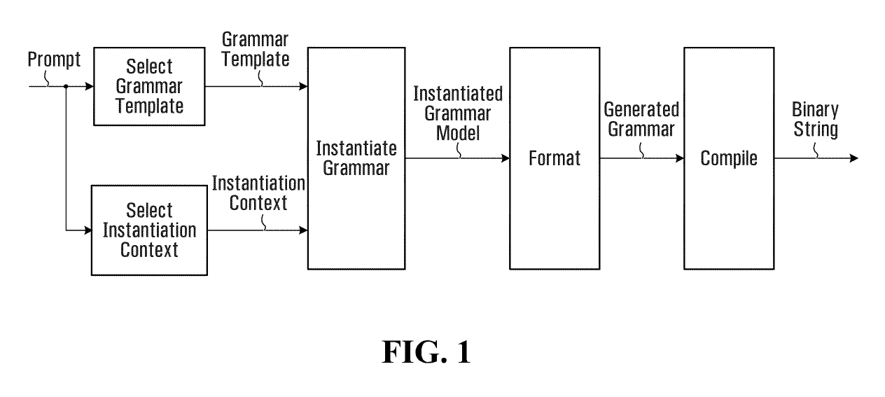

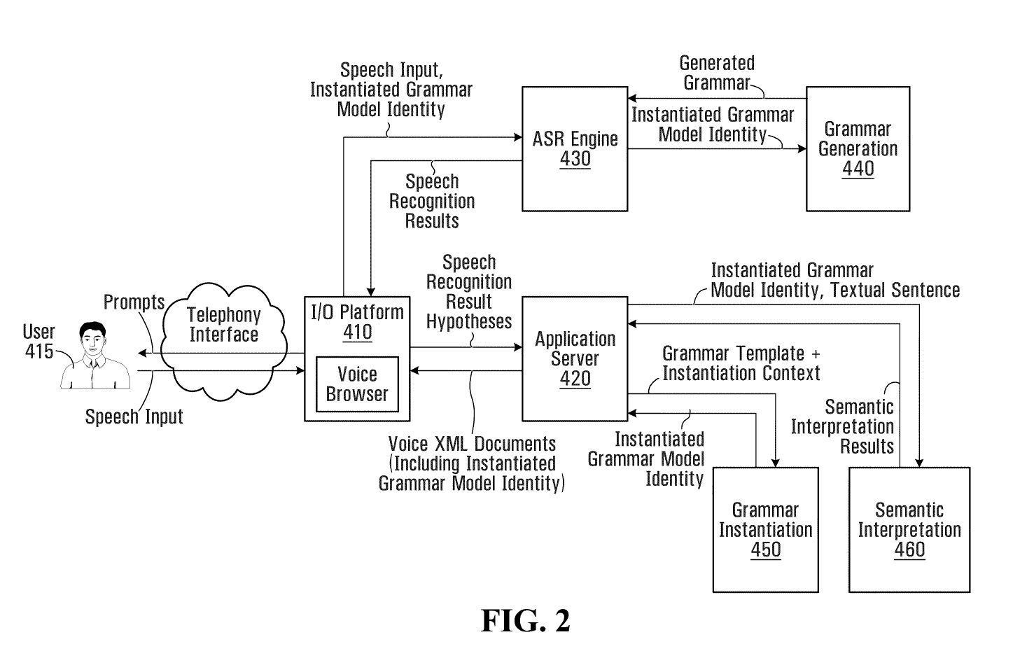

The instantiation context can be a data object (e.g., a file) written in a specific format such as JSON (JavaScript Object Notation), for example. The instantiation context can contain data that is matched to the grammar template so that proper instantiation can occur. In particular, with reference to FIG. 1, instantiation occurs by invoking a grammar template at run-time and specifying an instantiation context for use with the grammar template. This amounts to “calling” the grammar template with the instantiation context. The instantiation context can be created on-the-fly by the application, based on data obtained at run-time. This data can be found in a database or elsewhere. One exception is when “test instantiation contexts” are used during grammar development and maintenance in order to test the grammar.

Identification of the grammar template and the instantiation context is a function of where the application server is currently located in the dialog. For example, in a bill payment application, having identified that the user is John Smith, then the next step in the dialog may be to identify which bill John Smith wishes to pay. As such, the grammar template, which may pertain generally to recognizing the names of individual utilities, may be invoked using the “instantiation context” consisting of the list of potential bill payees for John Smith. Each of these bill payees may in turn have one or more aliases or alternatives (e.g., “AIG” or “American International Group”), in which case the instantiation context will include the principal names and aliases for each of these payees.

The instantiation context is structured in such a way that it is compatible with the grammar template. The grammar template and the instantiation context are then combined (instantiated) to form an instantiated grammar model. Specifically, the grammar template is populated with the data contained in the instantiation context, resulting in the instantiated grammar model. In this example, the instantiated grammar model would include the list of possible sentences that John Smith can be expected to utter in respect of making a selection of which bill to pay. However, in order for the instantiated grammar model to be of practical use to the speech recognition engine, it must be converted into a binary string. This can be achieved by formatting the instantiated grammar model into a generated grammar having an acceptable syntactic format (e.g., ABNF, XML, etc.), following which a grammar compiler may be used to create the binary string used by the speech recognition engine.

One non-limiting implementation of a speech platform that utilizes the aforementioned features of a grammar template and an instantiation context is shown in FIG. 2, which illustrates an I/O platform 410, an application server 420, an ASR engine 430, a grammar generation functional entity 440, a grammar instantiation functional entity 450 and a semantic interpretation functional entity 460.

The I/O platform 410 can be an Interactive Voice Response (IVR) platform implementing, for example, a voice browser (such as a VoiceXML browser) or a proprietary application development and runtime environment. A voice browser is functionally similar to a web browser (e.g., Internet Explorer™, Firefox™), with the main difference that, whereas a web browser fetches and renders HTML documents designed to provide a display/keyboard/mouse type of interface, a voice browser fetches and renders documents, such as VoiceXML documents, designed to provide a spoken dialog interface (speech output, speech/DTMF input). Fetched VoiceXML documents may include an identity of an instantiated grammar model to be used by the ASR engine 430, as well as prompts to be issued to a user 415 over a telephony interface (e.g., T1, VoIP, etc.). The identity of the instantiated grammar model can be expressed as a URI (uniform resource indicator), which is a unifying syntax for the expression of names and addresses of objects on a network. The voice browser may also include caching and expiration of fetched documents.

The I/O platform 410 interacts with other elements of the speech platform by:
fetching VoiceXML documents from the application server 420;
issuing prompts to the user 415 over the telephony interface;
receiving speech input from the user 415 over the telephony interface;
identifying an instantiated grammar model to the ASR engine 430.

This can include, for example, sending a URI of the instantiated grammar model;
sending speech input received from the user 415 to the ASR engine 430;
receiving speech recognition results from the ASR engine 430. This could include one or more recognition hypotheses, each of which contains raw recognized text, and possibly a semantic interpretation and other information, for instance word and sentence confidence scores;
sending received speech recognition results to the application server 420.

The application server 420 can be implemented in hardware, software, control logic or a combination thereof. The application server 420 executes instructions relating to a speech application calling for a dialog with the user 415. Based on semantic interpretation results, the application server 420 determines which VoiceXML documents to send to the voice browser (it is to be noted that the VoiceXML documents can be dynamically generated), or may take other actions such as suspension or termination of the speech application, setting an alarm or issuing a command to an external entity. The application server 420 also controls instantiation of grammar templates, as well as semantic interpretation, by invoking the appropriate functional entities when needed.

The application server 420 interacts with other elements of the speech platform by:
sending VoiceXML documents to the voice browser in the I/O platform 410;
receiving speech recognition results from the voice browser in the I/O platform 410;
identifying a grammar template and an instantiation context to the grammar instantiation functional entity 450. The grammar template can be identified by, for example, a URI;
receiving an identity of an instantiated grammar model from the grammar instantiation functional entity 450. This can include, for example, receiving a URI of the instantiated grammar model;
identifying an instantiated grammar model to the semantic interpretation functional entity 460. This can include, for example, sending a URI of the instantiated grammar model;
sending textual sentences to the semantic interpretation functional entity 460;
receiving semantic interpretation results returned by the semantic interpretation functional entity 460.

The grammar instantiation functional entity 450 operates on a grammar template and an instantiation context to produce an instantiated grammar model. The instantiated grammar model can ultimately be formatted by the grammar generation functional entity 440 into a generated grammar (in a format such as ABNF or XML, for example) so that the generated grammar, when compiled, can be used by the ASR engine 430 for producing recognition speech recognition results. In addition, the instantiated grammar model can be used by the semantic interpretation functional entity 460 in order to extract a meaning (or value) from textual sentences, whether or not they are constructed from the recognized text. Note that the grammar instantiation functional entity 450 can operate on different grammar templates and/or instantiation contexts to produce different instantiated grammar models for use by the grammar generation functional entity 440 and the semantic interpretation functional entity 460.

The grammar instantiation functional entity 450 interacts with other elements of the speech platform by:
receiving an identity of a grammar template and an instantiation context from the application server 420. This can include, for example, receiving a URI of the grammar template and receiving an instantiation context;
identifying an instantiated grammar model to the application server 420. This can include, for example, sending a URI of the instantiated grammar model;

The grammar generation functional entity 440 operates on an instantiated grammar model and knowledge of a format desired by the ASR engine 430 to produce a generated grammar. The format desired by the ASR engine 430 is assumed to be known in advance, or can be accessed by consulting a system variable, or can be identified by the ASR engine 130.

The grammar generation functional entity 440 interacts with other elements of the speech platform by:
receiving an identity of an instantiated grammar model from the ASR engine 430. This can include, for example, receiving a URI of the instantiated grammar model;
receiving a request for a generated grammar from the ASR engine 430. This request may be in the form of an HTTP fetch request, containing, in the form of a URI, the identity of the instantiated grammar model.
sending a generated grammar to the ASR engine 430.

The ASR engine 430 is used to recognize spoken input. The ASR engine 430 utilizes a generated grammar to determine speech recognition results corresponding to speech input received from the user 415 over the telephony interface. The speech recognition results can include one or more recognition hypotheses, each of which contains raw recognized text, and possibly a semantic interpretation and other information, for instance word and sentence confidence scores.

The ASR engine 430 interacts with other elements of the speech platform by:
receiving speech input from the I/O platform 410;
receiving an identity of an instantiated grammar model from the I/O platform 410;
sending a request for a generated grammar containing the identity of an instantiated grammar model to the grammar generation functional entity 440. The instantiated grammar model can be identified by, for example, a URI;
receiving a generated grammar from the grammar generation functional entity 440;
sending speech recognition results to the I/O platform 410. The semantic interpretation functional entity 460 (which may also sometimes be referred to as a sentence interpretation functional entity) operates on an instantiated grammar model and textual sentences to formulate semantic interpretation results for use by the application server 420 in determining further actions to take during the dialog with the user 415.

The semantic interpretation functional entity 460 interacts with other elements of the speech platform by:
receiving textual sentences from the application server 420;
receiving an identity of an instantiated grammar model from the application server 420. This can include, for example, receiving a URI of the instantiated grammar model;
sending semantic interpretation results to the application server 420.

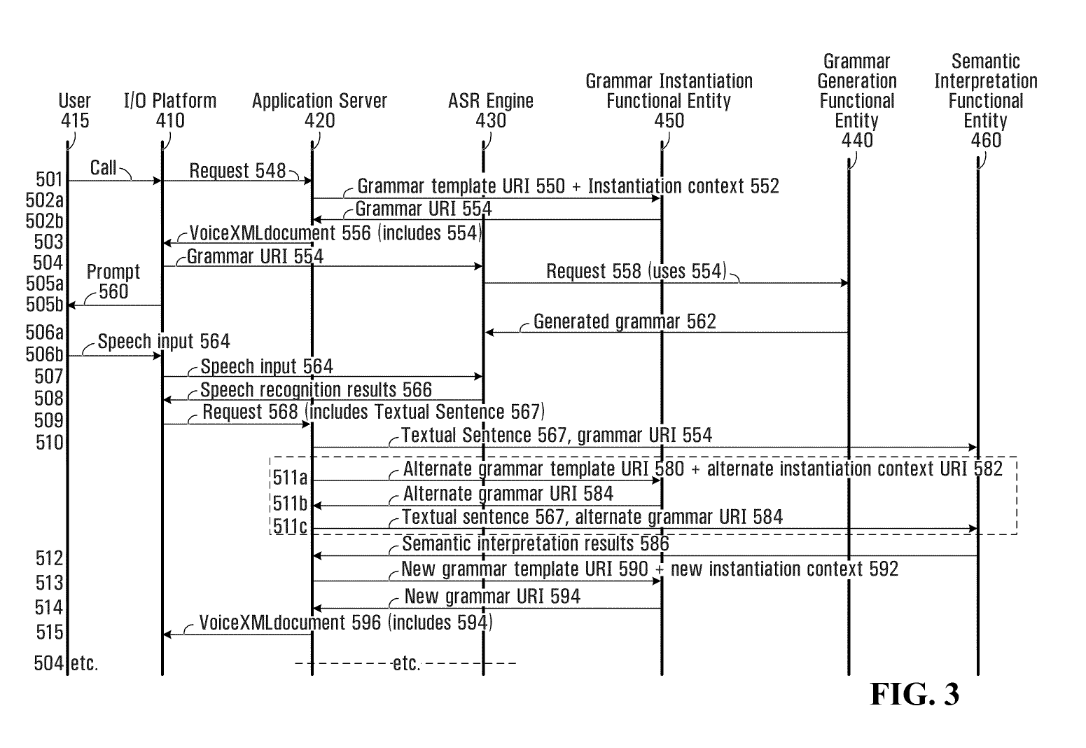

Operation of the non-limiting implementation of the speech platform in FIG. 2 in accordance with a non-limiting call scenario is now described with reference to the flow diagram in FIG. 3. Those skilled in the art will appreciate that in what follows, certain steps can be performed in an order different from the one in which they are described.

Step 501: The user 415 places a call to the I/O platform 410 over the telephony interface. For example, a connection can be established over the Public Switched Telephone Network (PSTN), where the I/O platform 410 is directly connected to a central office switch. Alternatively, the I/O platform 410 can be connected to a private branch exchange (PBX), itself connected to a central office switch. The I/O platform makes a request 548 for a VoiceXML document from the application server 420.

Step 502a: The application server 420 knows where it is in the dialog and determines a suitable grammar template and a suitable instantiation context 552. The grammar template can be identified by a grammar template URI. The instantiation context 552 may be built based on data available at run-time. The grammar template URI 550 and the instantiation context 552 are provided to the grammar instantiation functional entity 450 in order to trigger creation of an instantiated grammar model. The instantiated grammar model is stored in a memory resource, which can be a shared memory resource accessible to any entity requiring access to the instantiated grammar models it stores. Various mechanisms to enable “sharing” of the instantiated grammar model will be apparent to those skilled in the art as being within the scope of the present invention.

Step 502b: The grammar instantiation functional entity 450 returns an instantiated grammar model identity (e.g., in the form of a URI, hence the simplified but non-limiting expression “grammar URI”) 554 to the application server 420.

Step 503: The application server 420 responds to the request 548 with a VoiceXML document 556 for interpretation by the voice browser in the I/O platform 410. The grammar URI 554 provided by the grammar instantiation functional entity 450 can be included in the VoiceXML document 556.

Step 504: The I/O platform 410 sends the grammar URI 554 to the ASR engine 430 and instructs it to load the corresponding generated grammar.

Step 505a: The ASR engine 430 sends a request 558 (e.g., an HTTP request) to the grammar generation functional entity 440 using the grammar URI 554.

Step 505b: The I/O platform 410 issues a voice prompt 560 to the user 415 based on the VoiceXML document 556. The voice prompt 560 requests a response from the user 415.

Step 506a: Based on the grammar URI 554 received from the ASR engine 430 at step 504, and based on prior or acquired knowledge of the format desired by the ASR engine 430, the grammar generation functional entity 440 produces a generated grammar 562, which is returned to the ASR engine 430. The generated grammar 561 is compiled and stored by the ASR engine 430 in a memory resource.

Step 506b: The user 415 provides speech input 564 in response to the voice prompt 560 issued at step 505a.

Step 507: The I/O platform 410 sends the speech input 564 to the ASR engine 430 for recognition using the generated grammar 562 obtained by the ASR engine 430 pursuant to step 506a.

Step 508: The ASR engine 430 carries out speech recognition of the speech input 564. The speech recognition is constrained by the generated grammar 562. The ASR engine 430 creates speech recognition results 566 and returns them to the I/O platform 410. The speech recognition results 566 can include one or more recognition hypotheses, each of which contains raw recognized text, and possibly a semantic interpretation and other information, for instance word and sentence confidence scores.

Step 509: The I/O platform 410 makes a request 568 (e.g., an HTTP request) to the application server 420 to fetch a subsequent VoiceXML document. The request 568 can contain the speech recognition results 566 (or portions thereof) in order to assist the application server 420 to produce a new VoiceXML document.

At least the following three embodiments are now possible. In a first embodiment, not explicitly shown in FIG. 3, the application server 420 utilizes the semantic interpretation included in the speech recognition results 566 received from the ASR engine 430. In this case, based on this semantic interpretation, the application server 420 advances to a new point in the dialog, determines a new grammar template and a new instantiation context and skips to step 513 below.

In a second embodiment, shown in FIG. 3 as step 510, the speech recognition results 566 include speech recognition hypotheses but do not include a semantic interpretation. In this case, the application server 420 creates or extracts a textual sentence 567 from the speech recognition result hypotheses 566. The application server 420 can send the textual sentence 567 and the grammar URI 554 (i.e., the URI of the instantiated grammar model obtained from the grammar instantiation functional entity 450 at step 502b) to the semantic interpretation functional entity 460.

In a third embodiment, shown in FIG. 3 as a dashed outline including steps 511a, 511b and 511c, the speech recognition results 566 include speech recognition hypotheses but either do not include a semantic interpretation or there is a semantic interpretation but it is ignored. In this case, a different instantiated grammar model is used to constrain semantic interpretation. In particular, at step 511a, the application server 420 identifies an alternate grammar template (e.g., by way of an alternate grammar template URI 580) and/or an alternate instantiation context 582. The alternate grammar template URI 580 and the alternate instantiation context 582 are provided to the grammar instantiation functional entity 450, triggering the creation of an alternate instantiated grammar model. At step 511b, the alternate instantiated grammar model is identified to the application server 420 in the form of an alternate grammar URI 584. The application server 420 then sends the textual sentence 567 and the alternate grammar URI 584 (i.e., the URI of the alternate instantiated grammar model obtained from the grammar instantiation functional entity 450 at step 511b) to the semantic interpretation functional entity 460.

Step 512: The semantic interpretation functional entity 460 carries out semantic interpretation, which is constrained by the grammar URI 554 (or by the alternate grammar URI 584). The semantic interpretation functional entity 460 returns semantic interpretation results 586 to the application server 420. Based on the semantic interpretation results 586, the application server 420 advances to a new point in the dialog and determines a new grammar template and a new instantiation context.

Step 513: The application server 420 identifies the new grammar template and the new instantiation context by way of a new grammar template URI 590 and a new instantiation context 592, respectively. The new grammar template URI 590 and the new instantiation context 592 are provided to the grammar instantiation functional entity 450, triggering the creation of a new instantiated grammar model.

Step 514: The grammar instantiation functional entity 450 returns a URI of the new instantiated grammar model (or new grammar URI) 594 to the application server 420.

Step 515: The application server 420 sends a new VoiceXML document 596 (containing the new grammar URI 594) to the I/O platform 410, and flow returns to step 504 described above.

It should be appreciated that the grammar generation functional entity 440, the grammar instantiation functional entity 450 and the semantic interpretation functional entity 460 provide individual processing functions that can be executed by a processing entity which may be distributed throughout the speech platform or centralized within a “grammar server”.

It should be appreciated that a static grammar can also be used for speech recognition (at step 506a) and/or semantic interpretation (at step 512), in which case the instantiation context is empty, and therefore the grammar template and the instantiated grammar model are identical.

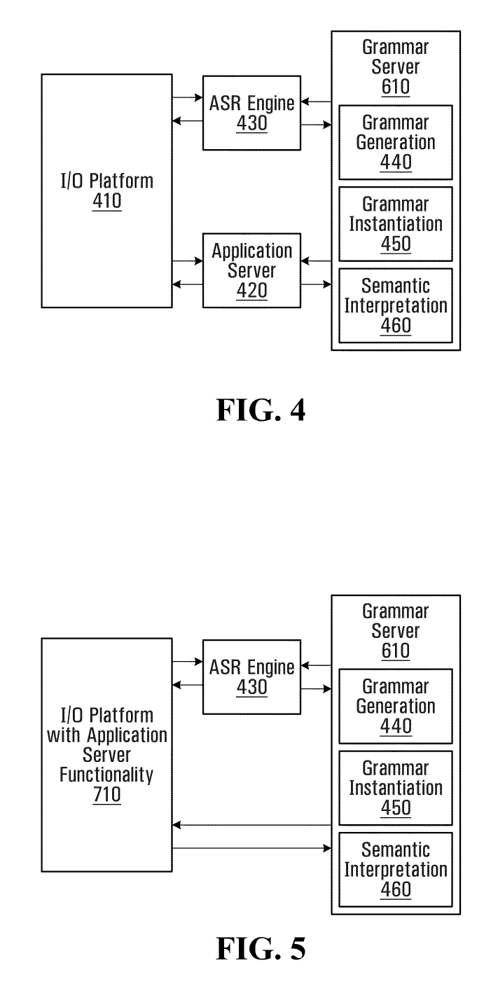

FIG. 4 illustrates the case where a grammar server 610 is provided. The grammar server 610 comprises a processing entity and a memory. The grammar server 610 could be dedicated to grammar services and operated by the operator of the application server 420. The availability of a locally controlled grammar server enables VoiceXML-application-hosting companies to add a grammar hosting service to their offering. Alternatively, the grammar server 610 could be accessible over the Internet and shared among different users requiring different grammar services. The availability of remotely hosted grammar servers in this way enables applications to be tested without having to set up any infrastructure whatsoever, thus enabling rapid prototyping of speech applications using dynamic grammars.

It should be appreciated that in some embodiments, the functionality of the application server 420 can be subsumed in the I/O platform 410. Specifically, as shown in FIG. 5, there is provided an I/O platform 710 which has taken over all functionality of the application server 420 shown in FIG. 4. This also covers the “static VoiceXML” scenario, where all application logic is directly coded into static VoiceXML documents, thereby eliminating the need for a separate application server to dynamically generate VoiceXML documents.

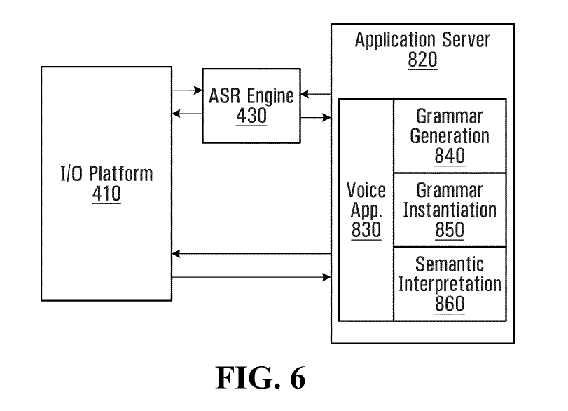

It is noted that the grammar server 610 continues to be present in the embodiments of FIGS. 4 and 5. However, as shown in FIG. 6, an alternative to having a grammar server is to provide the functional entities 440, 450, 460 as “embedded services” 840, 850, 860 of an application server 820. The embedded services 840, 850, 860 are made available to a voice application 830 through an application programming interface (API), which can be written in Java,.NET or any other language. The voice application 830 and the embedded services (i.e., the grammar generation embedded service 840, the grammar instantiation embedded service 850 and the semantic interpretation embedded service 86) can execute on the same application server 820, for example.

It should be appreciated that additional functional entities could be provided by the speech platform in the various embodiments of FIGS. 4, 5 and 6. In particular, the following is a non-limiting list of functional entities that can be provided:

Normalization functional entity: The instantiation context used to populate a grammar template may require some form of normalization in order to generate high-performance recognition grammars. For example, it may be beneficial to replace acronyms and abbreviations by their full textual form, to add aliases, to convert numbers into text in a language-dependent way, and so on. The normalization functional entity allows application-dependent normalization rules to be added.

Phonetic dictionary functional entity: To improve performance, it may be beneficial to provide a specially tuned phonetic dictionary (or lexicon) for use by the ASR engine 430 when performing speech recognition. The phonetic dictionary functional entity selects the specific dictionary subset corresponding to the vocabulary actually found in the generated grammar provided to the ASR engine 430. This process can be made totally transparent and can reduce compilation time.

Post-processing functional entity: A high-performance speech application may require the use of advanced algorithms in order to modify speech recognition results (for instance, to add, delete or reorder hypotheses) or to compute specialized scores required by the speech application. A simple example of this is the ability to compute grammar-specific scores that can be significantly better than the generic confidence scores provided by a standard ASR engine. The post-processing functional entity allows application-specific post-processing routines to be integrated using a unified interface.

Sentence generation functional entity: Testing of a speech application may be achieved by submitting a variety of spoken responses to prompts issued by the I/O platform 410. However, this can be tedious to do. The sentence generation functional entity can utilize an instantiated grammar model at any given point in the dialog to produce, on command, a random sentence that obeys the instantiated grammar model. This can facilitate as well as add a layer of objectivity to the testing. Also, the generated sentences can be supplied to a text-to-speech (TTS) device, which converts the text into a speech signal, which can then be used to fully test the speech application.

It should be appreciated that the various functional entities described above are separate processes and, as such, can be implemented by separate machines or any combination of the functional entities can be implemented by the same machine. Thus, a processing entity used to implement the various functional entities may be centralized or distributed. Consequently, one or more of the aforementioned functional entities can be used in contexts not necessarily involving speech recognition.

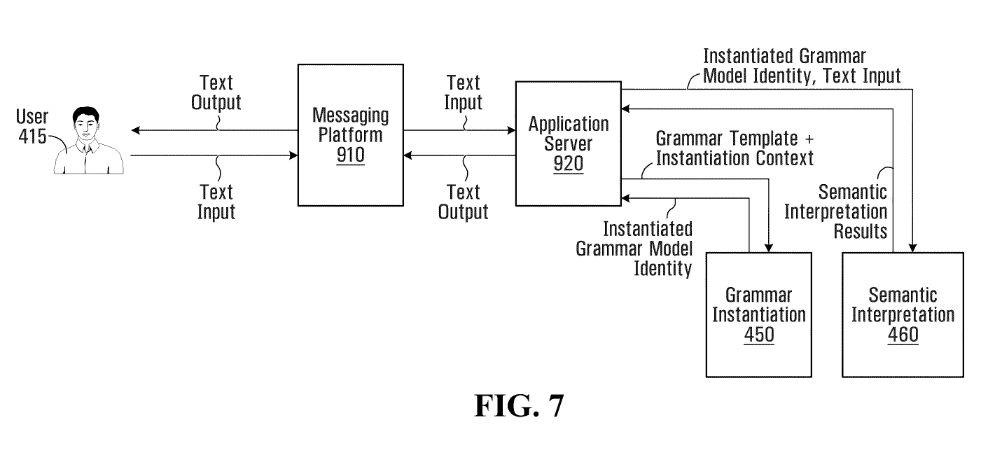

For example, FIG. 7 shows one non-limiting implementation of a text platform scenario which requires access to the aforementioned grammar instantiation functional entity 450 and semantic interpretation functional entity 460. In this scenario, there is no ASR engine and hence no need for a grammar generation functional entity, since the data is already input as text. More specifically, the user 415 dialogs with an automated text-based (instant message, text message, HTML, etc.) application residing on an application server 920 through an I/O platform that can be any one of a plurality of available messaging interfaces 910.

The messaging platform 910 can be an instant messaging (IM) gateway, a text message gateway or the like. In some embodiments, the messaging platform 910 can be incorporated with the application server 920. The messaging platform 910 can be reachable over a telephony or data network. Accordingly, the messaging platform 910 interacts with other elements of the text platform by:
receiving from the application server 920 text output destined for the user 415;
issuing text output to the user 415 over the telephony or data network;
receiving text input from the user 415 over the telephony or data network;
sending text input received from the user 415 to the application server 920;

The application server 920 can be implemented in hardware, software, control logic or a combination thereof. The application server 920 executes instructions relating to a text application calling for a text dialog with the user 415. Based on semantic interpretation results, the application server 920 determines which text output to send to the messaging platform 910, or may take other actions such as suspension or termination of the text application, setting an alarm or issuing a command to an external entity. The application server 920 also controls instantiation of grammar templates and semantic interpretation by invoking the appropriate functional entities when needed. Accordingly, the application server 920 interacts with other elements of the text platform by:
sending text output to the messaging platform 910;
receiving text input from the messaging platform 910;
identifying a grammar template (e.g., by way of a URI) and an instantiation context to the grammar instantiation functional entity 450;
receiving an identity of an instantiated grammar model from the grammar instantiation functional entity 450. This can include, for example, receiving a URI of the instantiated grammar model;
identifying an instantiated grammar model to the semantic interpretation functional entity 460. This can include, for example, sending a URI of the instantiated grammar model;
sending received text input to the semantic interpretation functional entity 460;
receiving semantic interpretation results returned by the semantic interpretation functional entity 460.

As previously described, the grammar instantiation functional entity 450 operates on a grammar template and an instantiation context to produce an instantiated grammar model. An instantiated grammar model can also be used by the semantic interpretation functional entity 460 in order to extract a meaning (or value) from text input. Accordingly, the grammar instantiation functional entity 450 interacts with other elements of the text platform by:
receiving an identity of a grammar template and an instantiation context from the application server 920. This can include, for example, receiving a URI of the grammar template and receiving the instantiation context;
identifying an instantiated grammar model to the application server 920. This can include, for example, sending a URI of the instantiated grammar model;

As previously described, the semantic interpretation functional entity 460 operates on an instantiated grammar model and text input to formulate semantic interpretation results for use by the application server 920 in determining further actions to take during the text dialog with the user 415. Accordingly, the semantic interpretation functional entity 460 interacts with other elements of the text platform by:
receiving text input from the application server 920;
receiving an identity of an instantiated grammar model from the application server 920. This can include, for example, receiving a URI of the instantiated grammar model;
sending semantic interpretation results to the application server 920.

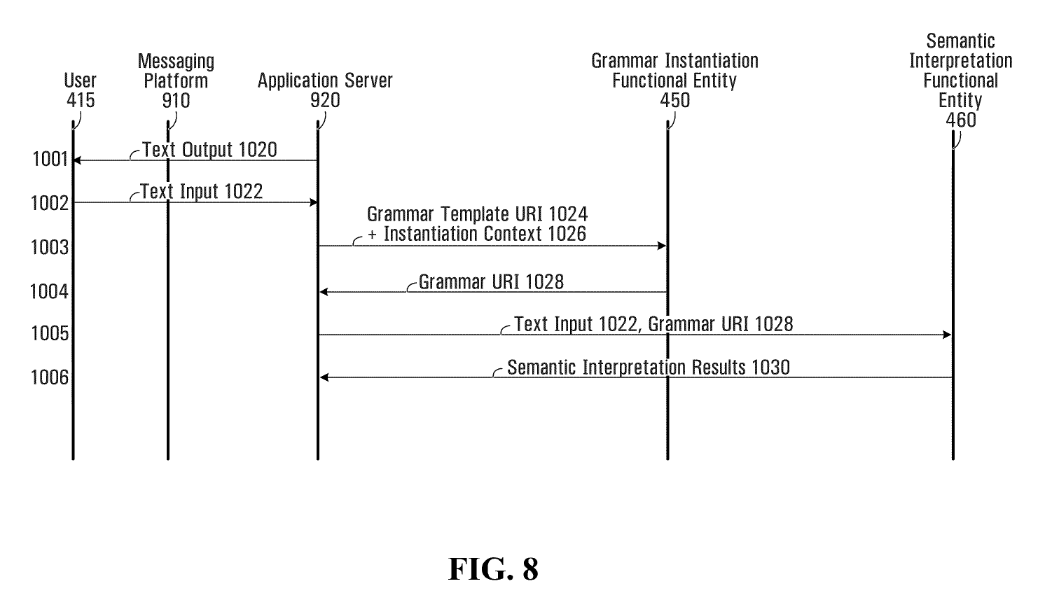

Operation of the non-limiting implementation of the text platform in FIG. 7 in accordance with a non-limiting text scenario is now described with reference to the flow diagram in FIG. 8. Those skilled in the art will appreciate that in what follows, certain steps can be performed in an order different from the one in which they are described.

Step 1001: The application server 920 causes text output 1020 to be sent to the user 415 via the messaging platform 910.

Step 1002: The application server 920 receives text input 1022 from the user 415 via the messaging platform 910.

Step 1003: The application server 920 knows where it is in the text dialog and determines a grammar template 1026 and an instantiation context. The grammar template can be identified by a grammar template URI 1024. The instantiation context 1026 may be built based on data available at run-time. The grammar template URI 1024 and the instantiation context 1026 are provided to the grammar instantiation functional entity 450 in order to trigger creation of an instantiated grammar model. The instantiated grammar model is stored in a memory resource, which can be a shared memory resource accessible to any entity requiring access to the instantiated grammar models it stores. Various mechanisms to enable “sharing” of the instantiated grammar model will be apparent to those skilled in the art as being within the scope of the present invention.

Step 1004: The grammar instantiation functional entity 450 returns a URI of the instantiated grammar model (or “grammar URI”) 1028 to the application server 420. It should be understood that steps 1003 and 1004 are optional if the instantiated grammar model is known a priori to the application server 920, that is to say, in a static grammar scenario .

Step 1005: The application server 920 sends the text input 1022 and the grammar URI 1028 to the semantic interpretation functional entity 460.

Step 1006: The semantic interpretation functional entity 460 carries out semantic interpretation, which is constrained by the grammar URI 1028. The semantic interpretation functional entity 460 returns semantic interpretation results 1030 to the application server 920. Based on the semantic interpretation results 1030, the application server 920 advances to a new point in the text dialog and returns to step 1001 described above.

Again, it should be appreciated that the grammar instantiation functional entity 450 and the semantic interpretation functional entity 460 provide individual processing functions that can be distributed throughout the text platform or centralized within a grammar server.

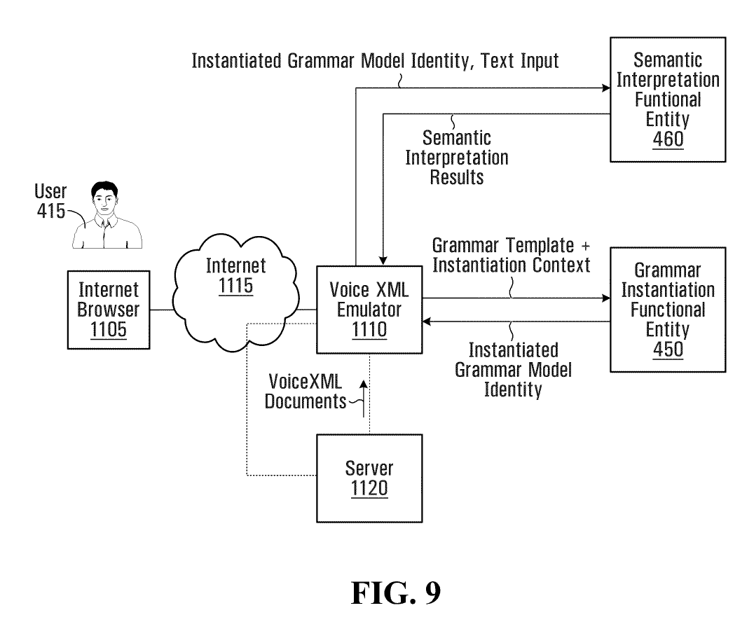

In another example that benefits from separating the grammar instantiation functional entity 450 and the semantic interpretation functional entity 460, FIG. 9 shows one non-limiting implementation of a VoiceXML emulation platform. In this scenario, the user 415 employs an Internet browser 1105 to interact with a VoiceXML emulator 1110, which is an interpreter for the VoiceXML language using only textual sentences as input, instead of DTMF sequences or speech. Such an emulator could serve as a means of testing a telephony application without having to deploy a cumbersome telephony infrastructure. Additionally, it could serve as a means of offering alternate interfaces to a phone-based system.

The VoiceXML emulator 1110 fetches a VoiceXML document from a server 1120 (such as an application server or a standard web-based server). The VoiceXML Emulator 1110 presents the next interaction with the user 415 using HTML or any other applicable protocol in use by the Internet browser 1105. Specifically, the VoiceXML emulator 1110 sends text to the user 415 instead of playing prompts, following which the VoiceXML emulator 1110 receives text input from the user 415 and interprets the received text input.

The received text input is interpreted based on the grammar specified in the VoiceXML document instead of performing speech recognition. In order to do this, the VoiceXML emulator 1110 first invokes the grammar instantiation functional entity 450 with a grammar template that calls for a grammar URL and an instantiation context composed of the grammar URL contained in the VoiceXML document. The resulting instantiated grammar model is then supplied, along with the received text input, to the semantic interpretation functional entity 460.

It should also be appreciated that a VoiceXML document may specitfy multiple grammars that need to be activated at the same time. To this end, the grammar template may be provided to the grammar instantiation functional entity 450 by the application server 420, the application server 720 or the VoiceXML emulator 1110 and thus may call for multiple alternative grammar URLs and thus the corresponding instantiation context would be composed of the multiple alternative grammar URLs contained in the grammar template. In this way, the grammar template provide an effective way of simulating the simultaneous activation of multiple grammars, which is equivalent to a single large grammar, itself the union of the multiple specified gramamrs. If the VoiceXML document contains inlined grammars, then these could also be provided in the instantiation context and integrated as individual grammar rules.

Those skilled in the art will appreciate that still further applications are made possible by the use of grammar templates and instantiation contexts to create instantiated grammar models which can be used, separately and independently, by the grammar generation functional entity 440 (where applicable) and the semantic interpretation functional entity 460.

For example, when an ASR engine 430 is used, advanced semantic interpretation technologies (e.g., robust parsing or topic spotting) can be enabled in a way that is completely independent from the ASR engine 430.

Also, embodiments of the present invention facilitate the performance of batch speech recognition tests in a dynamic grammar scenario. Specifically, batch speech recognition tests are performed in order to measure, analyze, and improve speech recognition accuracy (e.g., by tuning grammar coverage, tuning phonetic pronunciations, etc.). In accordance with an embodiment of the present invention, a batch recognition test can be performed so that each one of possibly several thousand utterances (or groups of utterances) he is recognized using a grammar resulting from instantiation of a grammar template and an utterance-specific (or utterance group-specific) instantiation context. A non-limiting example application of a batch speech recognition test is a batch address recognition test, in which the speech grammar that one desires to use to recognize each utterance (expected to contain an address) is generated based on an instantiation context containing address records associated with a list of postal codes coming from the recognition of a previous postal code dialog interaction.

In principle, since a grammar template is a text file, it can be created using any editor even as basic as Notepad™. There are, however, structural and formatting requirements to be followed if instantiation of the grammar template based on an instantiation context is to result in an instantiated grammar model capable of being successfully compiled into a valid generated grammar. To this end, it may be beneficial to provide a specific grammar authoring environment, which assists a developer in the creation and testing of grammar templates. The grammar authoring environment can be implemented on a computer by a set of computer-readable instructions stored in a memory of the computer. By way of specific non-limiting example, the computer-readable instructions can be formulated as a plug-in to an Eclipse-based authoring platform.

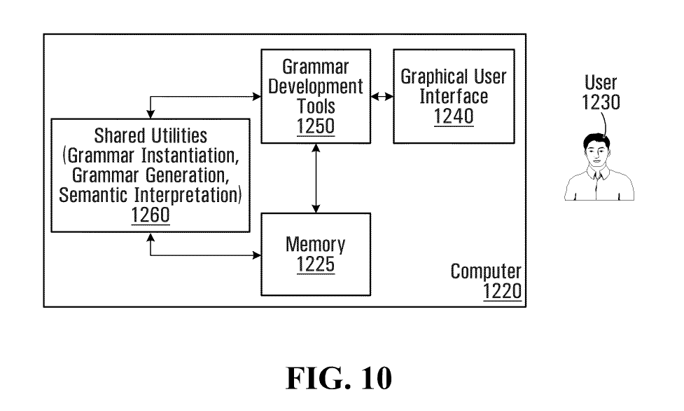

With reference to FIG. 10, a grammar authoring environment is implemented on a computer 1220 with a memory 1225. The grammar authoring environment provides a user (e.g., a grammar developer) 1230 with a graphical user interface 1240 via which the user 1230 can invoke a plurality of grammar development tools 1250. The grammar development tools 1250 can help the user 1230 to interactively explore and analyze grammar structure at various stages of grammar development, as well as see resulting sentences and their semantic interpretation. This can be of particularly high value when dealing with complex grammars.

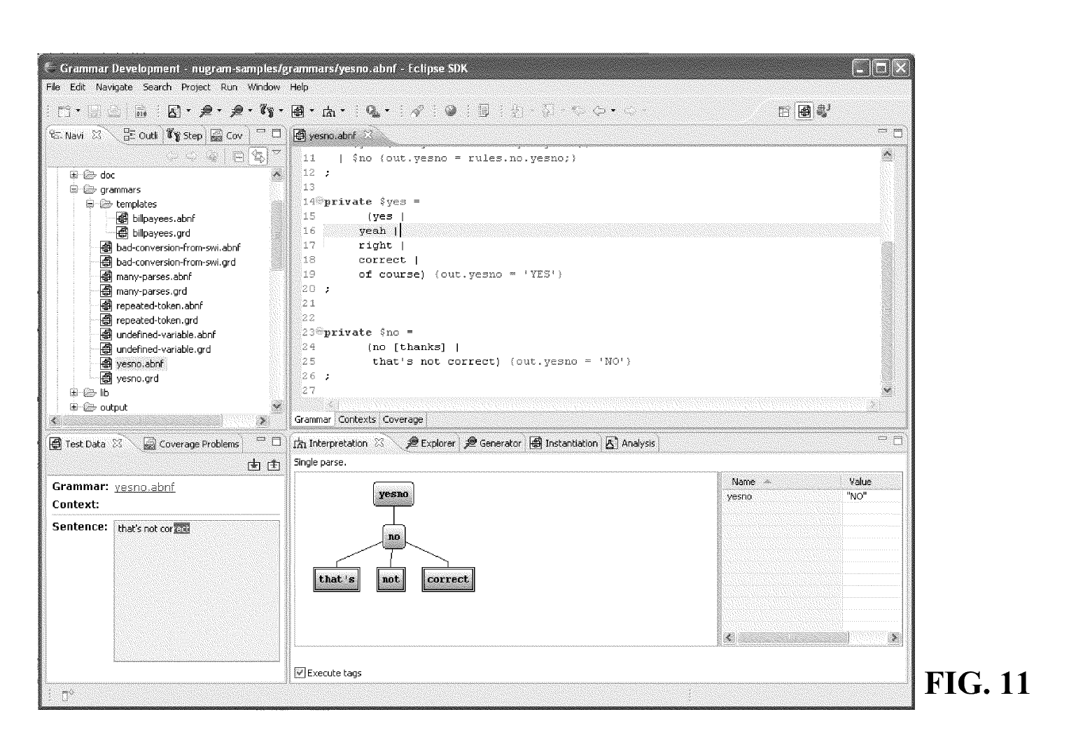

FIG. 11 shows an example screenshot of the grammar authoring environment as may be presented to the user 1230 via the graphical user interface 1240. From the screenshot are visible various windows providing access to different ones of the grammar development tools 1250.

The various grammar development tools 1250, when invoked, require the computer 1220 to access items in the memory 1225 and to interface further with the user 1230 via the graphical user interface 1240. To this end, the memory 1225 may store (i) one or more grammar templates; (ii) one or more instantiation contexts; (iii) instantiated grammar models resulting from instantiating given ones of the grammar templates with the corresponding instantiation contexts; (iv) generated grammars in one or more syntactic formats. Other items can be stored in the memory 1225 without departing from the scope of the present invention.

In addition, the grammar authoring environment renders available a set of shared utilities 1260 that can be used by various ones of the grammar development tools 1250. The shared utilities 1260 may include (i) a grammar instantiation utility which, similarly to the grammar instantiation functional entity 450, instantiates a grammar template with an instantiation context; (ii) a grammar generation utility which, similarly to the grammar generation functional entity 440, compiles an instantiated grammar model into a suitable format; (iii) a semantic interpretation utility which, similarly to the semantic interpretation functional entity 460, generates semantic interpretation results based on an input sentence and an instantiated grammar model. Other shared utilities are possible without departing from the scope of the present invention.

Of course, it should be understood that the computer-readable instructions encoding the shared utilities 1260, the grammar development tools 1250 and the graphical user interface 1240 may execute on a single machine or on a combination of machines, which can be co-located or can be distributed but interconnected via a data network such as the Internet, for example.

The grammar development tools 1250 can include, without limitation, one or more of a grammar editor, an instantiation debugger, a coverage test editor, a coverage test runner, a sentence interpreter, a semantic stepper, a sentence explorer and a sentence generator. Each of the aforementioned grammar development tools 1250 is briefly described herein below.

Grammar Editor: The grammar editor allows creation of a grammar template. The grammar editor receives input from the graphical user interface 1240 (e.g., via a keyboard, mouse, etc.) to allow the user 1230 to modify the grammar template stored in the memory 1225. Also, the grammar editor interprets the grammar template stored in the memory 1225 to provide advanced editing features that can be visually observed by the user 1230 via the graphical user interface 1240 (e.g., via a window presented on a display). Examples of advanced editing features can include syntax coloring, code folding, code assist (contextual completion, quick fixes, code templates) and refactorings (renamings, extractions, etc.), to name a few non-limiting possibilities.

The advanced editing features are made possible through the use of a grammar template language. The grammar template language can be based on a format used for generated grammars, such as ABNF or XML (for example), with special extensions added to designate dynamic portions requiring population by data obtained from an instantiation context. These special extensions can be recognized by the grammar editor and interpreted accordingly. Also, these special extensions are understood by the grammar instantiation process.

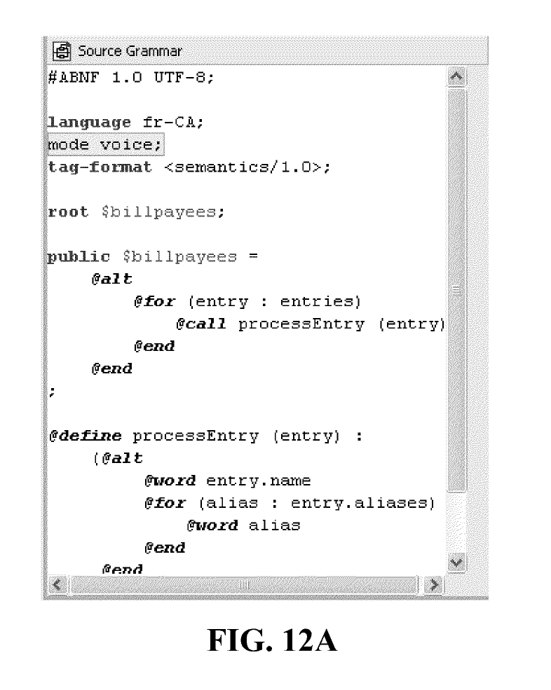

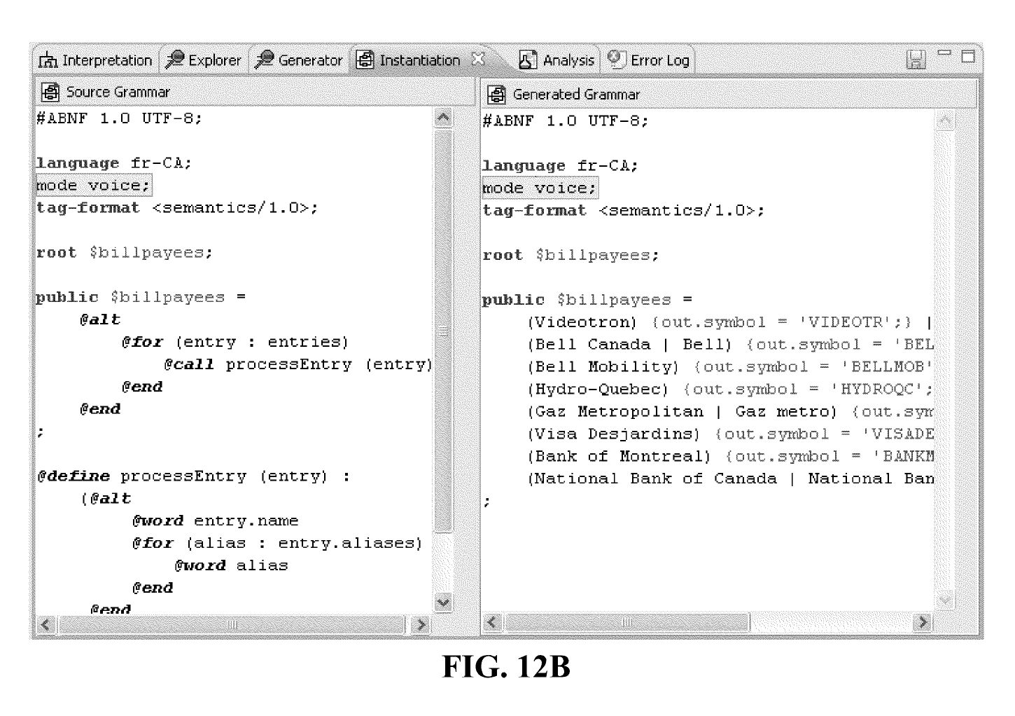

Specifically, with reference to FIG. 12A, there is shown a non-limiting example grammar template constructed using an example grammar template language. Here, the application is a bill payment voice application in which callers are asked to provide the name of a bill payee from a list of “entries” for that caller. Since different callers have different lists of bill payee “entries”, the grammar to be used for recognizing the bill payee identified by a given caller is not known until the caller has been identified. This is an example of a dynamic grammar scenario, where at a given point in the dialog, a grammar template (e.g., the one listed in FIG. 12A) needs to be instantiated with an instantiation context. It is noted that the instantiation context referred to in the grammar template (namely, the data represented by “entries”, i.e., the list of bill payees), is different for each caller and is not known until run-time.

To represent this dynamic aspect, a non-limiting example grammar template language uses the “@” symbol to indicate dynamic content. In particular, “@alt” indicates that several alternatives are possible. Next, “@for (entry: entries)” signifies for each element of the instantiation context called “entries”, do what follows, which is “@ call processEntry (entry)”. For its part, “@ call processEntry (entry)” is defined lower on the page, as a set of entries with alternatives of its own. That is to say, not only does “entries” include a list of bill payees with a primary “name” (defined as “entry.name”), but each of these bill payees possibly has a set of aliases found in a data file called “entry.alias”, where “entry” is in fact variable.

Conveniently, the grammar editor indicates graphically that certain data is dynamic in nature, in this case by placing in bold italics what follows the “@” symbol. As can be appreciated, the grammar template language affords a seamless evolution from static to dynamic grammars, and makes it possible to have a unified grammar development environment that can transparently be used for static and dynamic grammars.

In addition, the grammar editor continuously invokes the grammar instantiation utility, which is also configured to recognize the grammar template language. The grammar instantiation utility continuously instantiates the grammar template using the instantiation context identified therein. This results in an instantiated grammar model, which is stored in the memory 1225. The grammar instantiation utility can include a validation component, which identifies syntactic and semantic errors in the instantiated grammar model. Errors are returned to the grammar editor, which can re-present the errors to the user 1230 via the graphical user interface 1240 in the form of color, sound, etc. Similarly, the user 1230 can be alerted as to the consistency of semantic action tags.

Instantiation Debugger: The instantiation debugger takes a grammar template (e.g., one created using the grammar editor mentioned above) and shows the resulting generated grammar. As shown in FIG. 12B, the instantiation debugger receives input from the graphical user interface 1240 (e.g., via a keyboard, mouse, etc.) to allow the user 1230 to select a point in the grammar template (previously shown in FIG. 12A). Additionally, the instantiation debugger locates the corresponding point in the resulting generated grammar and displays both in a side-by-side fashion via the graphical user interface 1240 (e.g., via a window presented on a display). Using the instantiation debugger, which is programmed to interpret the grammar template in accordance with the rules of the grammar template language, dynamic fragments are made distinguished from non-dynamic fragments, thus allowing the user to retrace which parts of the resulting generated grammar were produced by dynamic fragments.

To this end, the instantiation debugger invokes the grammar instantiation utility, by virtue of which the grammar template is instantiated using the instantiation context identified in the grammar template. Additionally, the instantiation debugger invokes the grammar generation utility, by virtue of which the instantiated grammar model is compiled into a selected format.

In this specific non-limiting example, the bill payee list, which is dynamically defined for each user, includes “Videotron”, “Bell Canada”, “Bell Mobility”, etc., and each of these has a set of zero or more generally accepted alternatives or aliases (e.g., Bell Canada has “Bell”, Gaz Metropolitan has “Gaz Metro”).

It should be noted that the grammar template language can be based on a standard language (e.g., XML, ABNF) with extensions to accommodate dynamic fragments, while the generated grammar can be in the same standard language or in a different language. For example, one window could be used to edit the grammar template written in a language resembling ABNF (with extensions to accommodate dynamic fragments), while another window could be used to show the generated grammar in XML. Indeed, the instantiation debugger can be enhanced with the functionality to convert a generated grammar from one format to another when required.

Coverage Test Runner: When run, coverage tests results are presented in a dedicated view that shows key metrics about the test (number of tests that passed, number of tests that failed, percentage of grammar words covered by the tests, etc.). Grammar coverage tests can be performed interactively or as part of a build process to always make sure that no grammar coverage or semantic interpretation problem has accidentally been introduced.

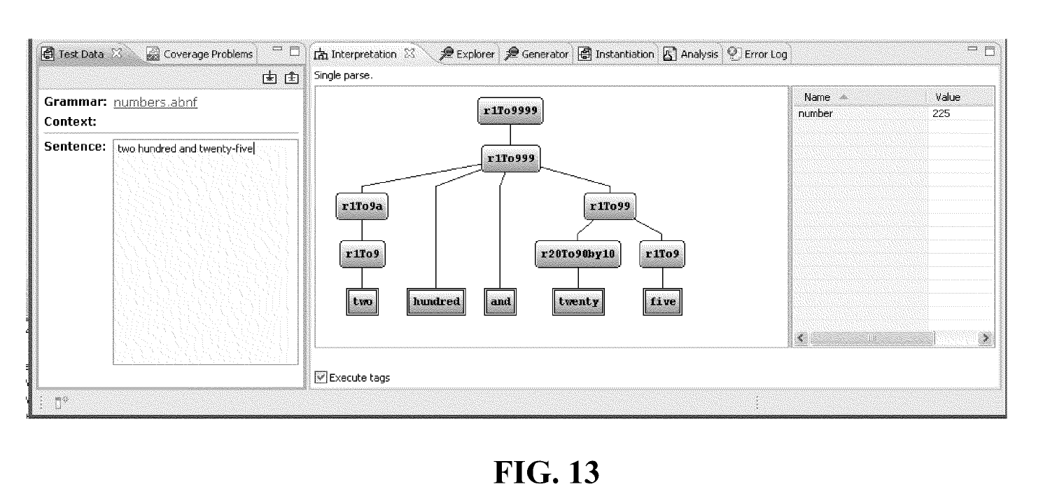

Sentence Interpreter: With reference to FIG. 13, the Sentence Interpreter is used to parse sentences interactively. The graphical parse tree (how rules are combined to generate the sentence) is displayed and clicking on any tree node automatically highlights the corresponding source element in the appropriate grammar file. The interactive sentence interpreter graphically shows the full parse tree.

Coverage Test Editor: Using this tool, a coverage test for an instantiated grammar model can be devised. The coverage test includes sentences that must be recognized by the eventual grammar, as well as sentences that should not be covered. Each sentence can also specify an expected semantic interpretation. In a more complicated scenario, sentences can in fact be templates, indicative of where to find the data to be used in the test.

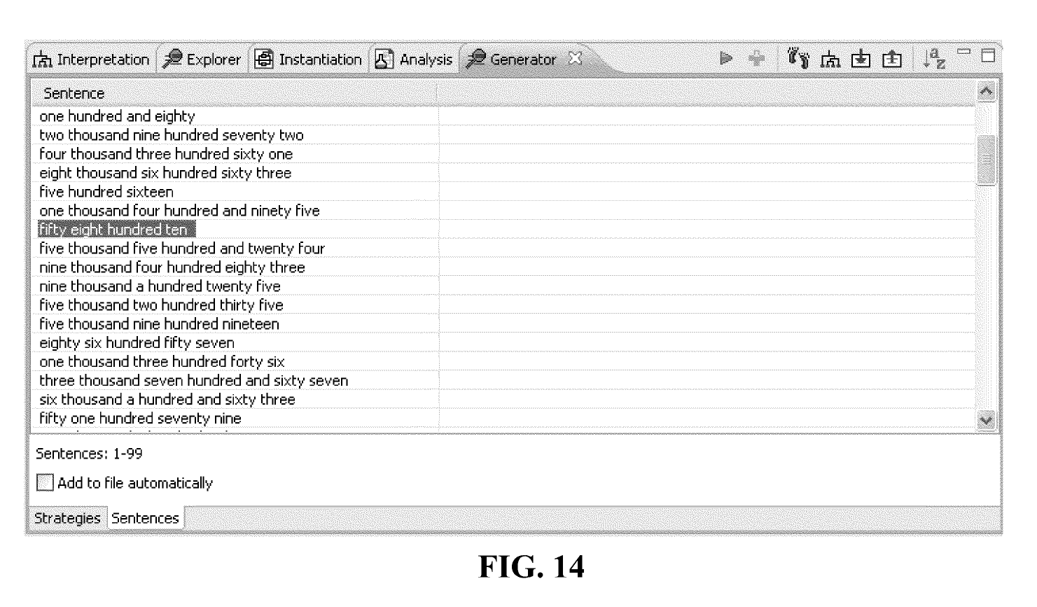

Sentence Generator: With reference to FIG. 14, the Sentence Generator is used to generate sentences interactively. The generation algorithm is highly configurable and can be used for many different purposes (random generation, full language generation, full grammar coverage, full semantic tags coverage, etc.). An intelligent and highly customizable sentence generation tool can be leveraged in many ways, for instance to help detect over-generation problems, to generate sets of sentences that exhaustively test all semantic tags in the grammar, or to produce coverage tests that cover all necessary sentence patterns. The Coverage Test Editor tool checks that the sentence can be parsed by the instantiated grammar model.

It will be appreciated that the Sentence Generator can be used to generate sentences for populating the coverage test, whereas the Coverage Test Editor enables a grammar developer to manually add, remove, and edit sentences in the coverage test, as well as changing certain properties for sentences in the coverage test (e.g., the expected semantic interpretation or the ING/OOG category).

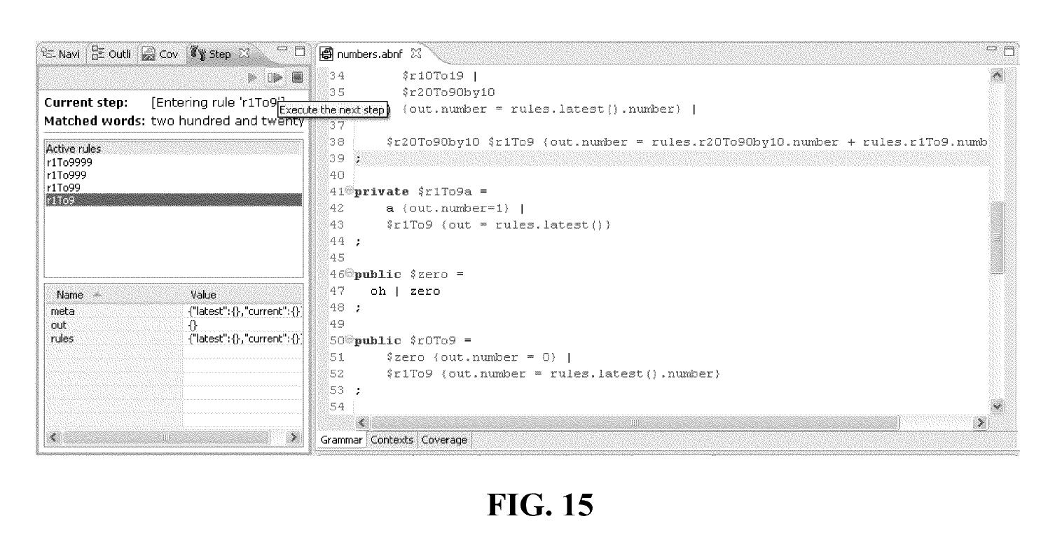

Semantics Stepper: With reference to FIG. 15, the Semantics Stepper is useful when a parsed sentence does not generate the correct semantic interpretation. It allows the developer to see the execution of each semantic tag and the context in which the execution takes place. Semantic interpretation can be debugged by single-stepping through the parsing and execution of semantic interpretation tags for any sentence.

Sentence Explorer: Using this tool, the structure of a grammar can be explored interactively. The user selects rules to be expanded one at a time until complete sentences are produced.

Those skilled in the art will therefore appreciate that integration among the various grammar development tools provided within the grammar authoring environment can be advantageous to a grammar developer.

Also, those skilled in the art will appreciate that the various grammar development tools available in the grammar authoring environment can be useful to application developers as well as grammar developers. Specifically, when implemented as a plug-in, the grammar authoring environment can allow a service creation environment (SCE) to provide better consistency checks between application code and the grammars used by the application, for instance by validating that the semantic slots returned by a grammar match those expected by the application and/or that the values expected by a grammar template are compatible with those provided by the application when instantiating the grammar template with a instantiation context. Carrying out such validations at development time instead of run-time can help build more reliable applications in a more cost-effective way.

Those skilled in the art will appreciate that in some embodiments, the functional entities 440, 450, 460, the graphical user interface 1240, the grammar development tools 1250 and the shared utilities 1260 may be achieved using one or more computing apparatuses that have access to a code memory (not shown) which stores computer-readable program code (instructions) for operation of the one or more computing apparatuses. The computer-readable program code could be stored on a medium which is fixed, tangible and readable directly by the one or more computing apparatuses, (e.g., removable diskette, CD-ROM, ROM, fixed disk, USB drive), or the computer-readable program code could be stored remotely but transmittable to the one or more computing apparatuses via a modem or other interface device (e.g., a communications adapter) connected to a network (including, without limitation, the Internet) over a transmission medium, which may be either a non-wireless medium (e.g., optical or analog communications lines) or a wireless medium (e.g., microwave, infrared or other transmission schemes) or a combination thereof. In other embodiments, the functional entities 440, 450, 460, the graphical user interface 1240, the grammar development tools 1250 and the shared utilities 1260 may be implemented using pre-programmed hardware or firmware elements (e.g., application specific integrated circuits (ASICs), electrically erasable programmable read-only memories (EEPROMs), flash memory, etc.), or other related components

While specific embodiments of the present invention have been described and illustrated, it will be apparent to those skilled in the art that numerous modifications and variations can be made without departing from the scope of the invention as defined in the appended claims.

What is claimed is:

1. A computing system comprising:
an I/O platform for interfacing with a user; and
a processing entity configured to implement a dialog with the user via the I/O platform, the processing entity being further configured for:
identifying a grammar template and an instantiation context associated with a current point in the dialog;
causing creation of an instantiated grammar model from the grammar template and the instantiation context;
storing the instantiated grammar model in a memory; and
interpreting user input received via the I/O platform in accordance with the instantiated grammar model.

2. The computing system defined in claim 1, wherein the user input comprises speech and wherein the interpreting comprises:
formatting the instantiated grammar model into a generated grammar;
carrying out recognition of the speech, wherein the recognition of the speech is constrained by the generated grammar.

3. The computing system defined in claim 2, wherein the interpreting further comprises carrying out semantic interpretation of the recognized speech.

4. The computing system defined in claim 1, wherein the user input comprises text.

5. The computing system defined in claim 4, wherein the interpreting comprises carrying out semantic interpretation of the text, the semantic interpretation being constrained by the instantiated grammar model.

6. The computing system defined in claim 5, wherein the text is obtained from the user over a data network.

7. The computing system defined in claim 5, wherein the processing entity is further configured for deriving the text by carrying out recognition of speech received from the user.

8. The computing system defined in claim 7, wherein the recognition of the speech is constrained by a generated grammar.

9. The computing system defined in claim 8, wherein the processing entity is further configured for formatting the instantiated grammar model into the generated grammar.

10. The computing system defined in claim 8, the instantiated grammar model being a second instantiated grammar model, wherein the processing entity is further configured for formatting a first instantiated grammar model into the generated grammar, the first instantiated grammar model being stored in the memory and being different from the second instantiated grammar model.

11. The computing system defined in claim 10, the grammar template being a second grammar template, the instantiation context being a second instantiation context, wherein the processing entity is further configured for:
identifying a first grammar template and a first instantiation context associated with the current point in the dialog;
causing creation of the first instantiated grammar model from the first grammar template data and the first instantiation context;
wherein at least one of the first grammar template and the first instantiation context is different from the second grammar template and the second instantiation context, respectively.

12. The computing system defined in claim 1, wherein causing creation of the instantiated grammar model from the grammar template and the instantiation context comprises populating the grammar template with the instantiation context.

13. The computing system defined in claim 12, wherein the instantiation context comprises data stored in the memory, for populating the grammar template at run-time.

14. The computing system defined in claim 1, wherein the processing entity is further configured for determining a new current point in the dialog and repeating the identifying, creating, storing and interpreting.

15. The computing system defined in claim 1, wherein the processing entity is further configured for advancing the dialog responsive to the interpreting.

16. The computing system defined in claim 1, wherein the I/O platform is VoiceXML-based.

17. The computing system defined in claim 1, wherein the I/O platform comprises a messaging platform.

18. The computing system defined in claim 1, wherein the I/O platform comprises a VoiceXML emulator.

19. The computing system defined in claim 1, wherein to cause creation of the first instantiated grammar model from the first grammar template data, the processing entity is configured to access a grammar instantiation functional entity.

20. The computing server defined in claim 19, wherein the grammar instantiation functional entity is implemented by the computing system.

21. The computing server defined in claim 19, wherein the grammar instantiation functional entity is implemented by a remote grammar server accessible over the Internet.

22. A method, comprising:
identifying a grammar template and an instantiation context associated with a current point in a dialog with a user that takes place via an I/O platform;
causing creation of an instantiated grammar model from the grammar template and the instantiation context data;
storing the instantiated grammar model in a memory; and
interpreting user input received via the I/O platform in accordance with the instantiated grammar model.

23. A computer-readable storage medium storing instructions for execution by a computer, wherein the instructions, when executed by a computer, cause the computer to implement a method, comprising:
identifying a grammar template and an instantiation context associated with a current point in a dialog with a user that takes place via an I/O platform;
causing creation of an instantiated grammar model from the grammar template and the instantiation context data;
storing the instantiated grammar model in a memory; and
interpreting user input received via the I/O platform in accordance with the instantiated grammar model.

24. Apparatus for sentence generation comprising:
a memory;
an output; and
a processing entity configured for:
identifying a grammar template and an instantiation context;
causing creation an instantiated grammar model from the grammar template and the instantiation context;
storing the instantiated grammar model in the memory;
generating at least one sentence constrained by the instantiated grammar model; and
releasing the at least one sentence via the output.

25. The apparatus defined in claim 24, wherein the output comprises the memory, and wherein to release the at least one sentence via the output, the processing entity is configured for storing the at least one sentence in the memory.

26. A method, comprising:
identifying a grammar template and an instantiation context;
causing creation of an instantiated grammar model from the grammar template and the instantiation context data;
storing the instantiated grammar model in a memory;
generating a sentence constrained by the instantiated grammar model; and
releasing the sentence via an output.

27. A computer-readable storage medium storing instructions for execution by a computer, wherein the instructions, when executed by a computer, cause the computer to implement a method, comprising:
identifying a grammar template and an instantiation context;
causing creation an instantiated grammar model from the grammar template and the instantiation context data;
storing the instantiated grammar model in a memory;
generating a sentence constrained by the instantiated grammar model; and
releasing the sentence via an output.

28. A computing device comprising a memory, a user interface and a processing unit, the memory storing instructions for execution by the processing unit, the memory further storing a grammar template, the memory further storing rules associated with a grammar template language, wherein the instructions, when executed by the processing unit, cause the processing entity to interpret the grammar template in accordance with the rules associated with the grammar language such that wherein when the grammar template includes dynamic fragments written in accordance with the grammar template language, the processing entity is responsive to identify the dynamic fragments and to control the user interface so as to render the dynamic fragments distinguishable from non-dynamic fragments.

29. A computer-readable storage medium storing instructions for execution by a computer, wherein the instructions, when executed by a computer, cause the computer to implement a plurality of grammar development tools and a graphical user interface, wherein the graphical user interface allows a user of the computer to invoke at least one of the grammar development tools, wherein at least one of the grammar development tools (i) allows a user to edit a grammar template via the graphical user interface; (ii) recognizes dynamic fragments in the grammar template; and (iii) identifies the dynamic fragments to the user via the graphical user interface.

30. The computer-readable storage medium defined in claim 29, wherein a further one the grammar development tools allows the user to (i) edit the grammar template via the graphical user interface and (ii) specify an instantiation context for use with the grammar template, wherein the instructions, when executed by the computer, further cause the computer to (i) instantiate the grammar template with the instantiation context to produce an instantiated grammar model and (ii) convey the instantiated grammar model to the user via the graphical user interface in a selected grammar format.

31. The computer-readable storage medium defined in claim 30, wherein additional ones the grammar development tools include one or more of a coverage test runner, a sentence interpreter a coverage test editor, a sentence generator, a semantics stepper and a sentence explorer.

32. A computer-readable storage medium storing instructions for execution by a computer, wherein the instructions, when executed by a computer, cause the computer to implement a plurality of grammar development tools and a graphical user interface, wherein the graphical user interface allows a user of the computer to invoke at least one of the grammar development tools, wherein at least one the grammar development tools allows a user to (i) edit a grammar template via the graphical user interface and (ii) specify an instantiation context for use with the grammar template, wherein the instructions, when executed by the computer, further cause the computer to (i) instantiate the grammar template with the instantiation context to produce an instantiated grammar model and (ii) convey the instantiated grammar model to the user via the graphical user interface in a selected grammar format.

33. The computer-readable storage medium defined in claim 32, wherein the instructions further cause the computer to implement a grammar instantiation functional entity for instantiating the grammar template with the instantiation context.
